(19) United States
(12) Patent Application Publication
(10) Pub. No.: US 2026/0154995 A1
(43) Pub. Date: Jun. 4, 2026

(54) WEB-BASED DISTRIBUTED MISSION PLANNING AND MEDIA MANAGEMENT SYSTEM AND METHOD

(71) Applicant: THE BOEING COMPANY, Arlington, VA (US)

(72) Inventors: Brian Anthony Wilson, Kent, WA (US); Daniel Allan Kimball, Puyallup, WA (US); Joshua David Jaross, Gig Harbor, WA (US)

(73) Assignee: THE BOEING COMPANY, Arlington, VA (US)

(21) Appl. No.: 19/379,302

(22) Filed: Nov. 4, 2025

Related U.S. Application Data
(60) Provisional application No. 63/727,866, filed on Dec. 4, 2024.

(51) Int. Cl. G07C 5/00; G05B 13/02; G08G 5/32

(52) U.S. Cl. CPC G07C 5/008; G05B 13/0265; G08G 5/32

(57) ABSTRACT

A computer-implemented method for distributed mission planning and media management for aircraft. The method includes providing a web-based architecture that allows multiple remote users to interact with a networked media station through a web interface. The networked media station contains multiple memory bays holding removable memories configured for insertion into different control systems of the aircraft. The method involves receiving user inputs via the web interface to create and manage pre-planned mission packages stored in the removable memories. The networked media station preemptively validates mission media to identify and report issues preventing successful implementation of the pre-planned mission packages. The removable memories are then loaded into the aircraft's control systems for mission execution. The method also includes simultaneous offloading of mission data post-mission, automatic report generation, and cloud-based storage for data redundancy. An artificial intelligence system analyzes mission media and pre-planned packages to provide recommendations for future missions.

### CROSS-REFERENCE TO RELATED APPLICATIONS

This application claims priority to U.S. Provisional Application No. 63/727,866 (filed 4 Dec. 2024), the entire disclosure of which is incorporated herein by reference.

### BACKGROUND

### Field of the Disclosure

The subject matter described herein relates to computer systems and software used to plan missions and manage media used onboard vehicles, such as aircraft, for completing the missions.

### Description of the Art

Various vehicles can require data for completion of missions. For example, some aircraft may surveille areas for other vehicles and/or perform other missions. This aircraft can be equipped with sonobuoys, magnetic anomaly detectors, advanced acoustics systems, infrared systems, etc. to detect and track submarines, missiles or other munitions to target threats, and the like. To perform or complete surveillance missions, these types of aircraft may require media (e.g., data) in mission plans to direct operations of the aircraft.

To complete these missions, various types of mission media may be needed. Some existing tools for mission planning and media management often restrict simultaneous user access. This can hinder collaboration. These tools typically operate on large desktop-based systems intended for use by a single person. This can limit configuration management and reproducibility. Integration with third-party tools can be costly and complex and can lead to inefficiencies. Validation gaps in current systems can result in mission failures, and data accessibility may be limited due to the inability to offload data from multiple aircraft partitions simultaneously. Additionally, the process of reviewing mission logs and generating reports post-missions can be cumbersome, thereby slowing down fault identification and analysis. A need may exist for a more efficient and collaborative solution for mission planning and media management.

### BRIEF SUMMARY

According to one example of the inventive subject matter, a computer-implemented method for distributed mission planning and media management for aircraft is provided. The method includes providing a web-based architecture that allows multiple remote users to interact with a networked media station through a web interface. The networked media station can have plural memory bays holding plural removable memories configured to be removed from the networked media station and inserted into different control systems of the aircraft. The method also can include receiving, at the networked media station, user input via the web interface to create and manage pre-planned mission packages for the aircraft. The pre-planned mission packages can be stored in one or more of the removable memories via the networked media station. The method also can include preemptively validating mission media represented by the pre-planned mission packages using the networked media station through the web interface to identify and report issues preventing successful implementation of any of the pre-planned mission packages on the aircraft. The one or more of the removable memories can be removable from the networked media station for loading into the different control systems of the aircraft for implementing the pre-planned mission packages using the aircraft.

According to another example, a computer-readable storage device stores instructions which, when executed by one or more processors, cause the one or more processors to perform operations for distributed mission planning and media management for aircraft. The operations can include providing a web-based architecture that allows multiple remote users to interact with a networked media station through a web interface. The networked media station can have plural memory bays holding plural removable memories configured to be removed from the networked media station and inserted into different control systems of the aircraft. The operations also can include receiving, at the networked media station, user inputs via the web interface to create and manage pre-planned mission packages for the aircraft. The pre-planned mission packages can be stored in one or more of the removable memories via the networked media station. The operations also can include preemptively validating mission media represented by the pre-planned mission packages using the networked media station through the web interface to identify and report issues preventing successful implementation of any of the pre-planned mission packages on the aircraft. The one or more of the removable memories can be removable from the networked media station for loading into the different control systems of the aircraft for implementing the pre-planned mission packages using the aircraft.

According to another example, a computer-implemented method for distributed mission planning and media management for aircraft can include providing a web-based architecture that allows multiple remote users to interact with a networked media station through a web interface. The networked media station can have plural memory bays holding plural removable memories configured to be removed from the networked media station and inserted into different control systems of the aircraft. The method also can include receiving, at the networked media station, user inputs via the web interface to create and manage pre-planned mission packages for the aircraft. The pre-planned mission packages can be stored in one or more of the removable memories via the networked media station. The pre-planned mission packages can be reused in the power systems of the aircraft or in another aircraft for future missions for consistent and reliable reproduction of the aircraft mission media. The one or more of the removable memories can be removable from the networked media station for loading into the different control systems of the aircraft for implementing the pre-planned mission packages using the aircraft.

### BRIEF DESCRIPTION OF THE DRAWINGS

FIG. 1 illustrates one example of a web-based distributed mission planning and media management system.

FIG. 2 illustrates a networked media station used for distributed mission planning and media management.

FIG. 3 illustrates a flowchart of one example of a method for distributed mission planning and media management.

FIG. 4 illustrates one example of a web interface for media management and build operations within the distributed mission planning and media management system.

FIG. 5 illustrates another example of a web interface for media management and build operations within the distributed mission planning and media management system.

FIG. 6 illustrates another example of a web interface for media management and build operations within the distributed mission planning and media management system.

FIG. 7 illustrates another example of a web interface for media management and build operations within the distributed mission planning and media management system.

### DETAILED DESCRIPTION

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

The inventive subject matter described herein provides a web-based architecture that allows multiple remote users to interact with a networked media station through a web interface. The system and method provide for real-time collaboration among users to facilitate creation and management of pre-planned mission packages for aircraft or other vehicles. A networked media station can include multiple memory bays holding removable memories. Each of these removable memories, or sleds, can receive mission media from the remote users via the web interface to create mission plans or mission media for use in controlling the aircraft during one or more upcoming missions.

Examples of the mission media or data can include maps and navigation data such as information related to flight paths, waypoints, and geographical coordinates to guide the aircraft during the mission; communication settings having configurations for radio frequencies, encryption keys, and communication protocols to ensure secure and effective communication with the aircraft; weapon systems configurations that specify types and quantities of weapons to be carried by the aircraft, as well as deployment settings of the weapons; sensor and surveillance data that includes pre-configured settings for sensors such as radar, sonar, infrared, and other surveillance equipment to detect and track targets; environmental data that includes information on weather conditions, terrain, and other environmental factors that may impact the mission; operational procedures such as detailed instructions and protocols for various mission scenarios, including search and rescue, reconnaissance, and combat operations; logistics and support data that includes information on fuel requirements, maintenance schedules, and support resources needed for the mission; intelligence data such as pre-mission intelligence reports, threat assessments, and other relevant information to inform mission planning and execution; mission logs and reports that record prior and/or upcoming mission activities, outcomes, and any issues encountered during the mission, etc. The media can include preflight insertion data (PID), which can be a mission-data package built during planning and loaded onto the aircraft before takeoff to initialize and configure onboard systems for that sortie or mission. The PID may include platform-specific items such as system and communications configurations required to bring mission subsystems online, stores or weapons inventory initialization and related setup for the mission computer, mission planning data formatted for the aircraft, and the like. The PID can be a pre-loaded configuration and mission dataset that enables the sensors, communications, and/or weapons systems of the aircraft to start in the correct state for the planned mission. The media can be stored in mission control and display system (MCDS) storage (e.g., data storage unit, or DSU) for classified data and/or unclassified data, cross domain storage for classified data, acoustics storage (embedded acoustic data recorder, acoustic flight data archive, or the like) for classified data, MCDS encrypted storage (e.g., data transport system), and the like.

The memory modules, or sleds can be loaded into different control systems onboard the aircraft. Examples of these systems can include radio systems that manage communication settings, including radio frequencies, encryption keys, and communication protocols for secure and effective communication during the mission; weapons systems for handling the configurations for the types and quantities of weapons to be carried by the aircraft, including deployment settings; navigation systems that use navigation data such as flight paths, waypoints, and geographical coordinates to guide the aircraft during the mission; sensor and surveillance systems that include radar, sonar, infrared, and other surveillance equipment for detecting and tracking targets; environmental monitoring systems that use environmental data, including weather conditions, terrain, and other factors that may impact the mission; operational systems that follow detailed instructions and protocols for various mission scenarios, such as search and rescue, reconnaissance, and combat operations; logistics and support systems that manage information on fuel requirements, maintenance schedules, and support resources needed for the mission; intelligence systems that use pre-mission intelligence reports, threat assessments, and other relevant information to inform mission planning and execution; mission logging systems that record mission activities, outcomes, and any issues encountered during the mission to provide data for post-mission analysis and future planning; and the like.

The systems and methods described herein also can support preemptive validation of mission media to ensure successful implementation of mission packages. This can involve checking the mission media for omissions, errors, incompatibilities, or the like, that may prevent the mission media from being successfully uploaded into the aircraft control systems, that can prevent the mission media from being compiled, or that otherwise prevent the mission media from being used by the control systems to use the media in performance of a mission. Previously with some known systems and methods, this validation was not performed until after the media was loaded into the control systems. If there were any issues, errors, or omissions in the media, then the media was required to be removed from the control system(s), taken back to the dedicated desktop computer for correcting the issues, errors, or omissions, and then taken back to the control system(s) again. This can be a time- and labor-intensive process prior to development of the inventive subject matter described herein.

The systems and methods described herein also can simultaneously offload mission data collected and/or generated by the aircraft control systems, automatically generate mission reports from this mission data, and integrate with third-party mission planning tools. For example, during missions, the control systems onboard the aircraft can collect a variety of mission data that can be useful for post-mission analysis and future planning. This data can include navigation data (flight paths, waypoints, and geographical coordinates that track movements of the aircraft throughout the mission), communication logs (that capture radio frequencies, encryption keys, and communication protocols used during the mission), weapons deployment data (that records the types and quantities of weapons used, along with deployment settings and outcomes), sensor and surveillance data from radar, sonar, infrared, and other surveillance equipment (to provide detailed information on detected and tracked targets), environmental data (that includes weather conditions, terrain information, and other environmental factors encountered during the mission), operational logs (that document execution of various mission scenarios, such as search and rescue, reconnaissance, and combat operations, detailing the procedures followed and any deviations), logistics and support data (that track fuel consumption, maintenance activities, and the utilization of support resources), intelligence data (that includes pre-mission intelligence reports, threat assessments, and real-time updates received during the mission), mission logs and reports (that include activities, outcomes, and issues encountered to provide a comprehensive record for post-mission debriefing and analysis), etc. This collected data and/or generated reports can be used for evaluation of the mission, identifying areas for improvement, and informing future mission planning.

The ability of the systems and methods to integrate with third-party mission planning tools can increase the flexibility and utility of the systems and methods. Allowing seamless integration through a web interface, the system and method can allow users to leverage existing mission planning resources without the need for costly and time-consuming redevelopment. This capability can help users to continue using familiar tools and software, thereby reducing learning curves and increasing efficiencies. The web-based architecture can incorporate various third-party tools, such as advanced mapping software, specialized communication protocols, and custom analytics platforms, into the mission planning and media management process. This interoperability can streamline the workflow but also ensure that the mission planning process is comprehensive and uses the best available technologies. As a result, the system and method can adapt to evolving mission requirements and incorporate new tools as they become available, thereby maintaining relevance and effectiveness in dynamic operational environments.

The web-based architecture of the systems and methods allows multiple remote users to interact with the networked media station through a web interface. This can provide for real-time collaboration and remove geographical barriers that previously may interfere with or delay creation and/or validation of mission media. This architecture can increase operational flexibility by allowing users to access and manage mission data from any location with an Internet connection.

The preemptive validation of mission media through the web interface identifies and reports issues before deployment, reducing the risk of mission failures and enhancing the reliability of mission planning processes. This validation step ensures that any potential problems are addressed before the mission media is implemented on the aircraft, thereby improving the overall success rate of missions.

Additionally, the systems and methods described herein may be used in connection with preparing and validating media packages for several aircraft. For example, a customer may have several dozen aircraft, and not all of the aircraft may have the same functional capability or baseline software. The systems and methods described herein can track or monitor the configuration of each aircraft, including which software release is required by each aircraft configuration.

For example, between a first and second release of aircraft fleet software, a file containing configuration settings of a radio frequency may require new fields of information to be included in a valid file for the second release of the fleet software. The file from the first release may not be compatible with the second release. The systems and methods described herein can identify this incompatibility and provide the user with guidance on making the file compatible with the second software release. The system can accurately track the origin mission package that contained the file for the first software release, and the new package that contains the updated file for the second software release. Many mission packages may be compatible with both software releases, and the system can track however many releases that each mission package is compatible with, as well as any future release.

The systems and methods described herein can support many fleet releases that support the unique configuration of each aircraft. Additionally, adding new fleet releases to the solution can be a seamless transition without requiring an entirely new workstation or operating system level update at the machines used by the users to support the new fleet release.

In certain examples, the systems and methods can use a plug-in architecture that enables the integration of training tools and other customer-specific applications. This allows users to install and access their own tools for training, planning, analysis, or replay within the mission planning and media management environment. The plug-in framework provides extensibility such that the core system may not require modification to support additional functionalities. Instead, users may incorporate their preferred or proprietary training tools as plug-ins, which can be accessed through the same web-based interface used for mission planning and media management. This design facilitates adaptability to diverse operational requirements and supports the seamless addition of new capabilities, including training modules, as user needs evolve.

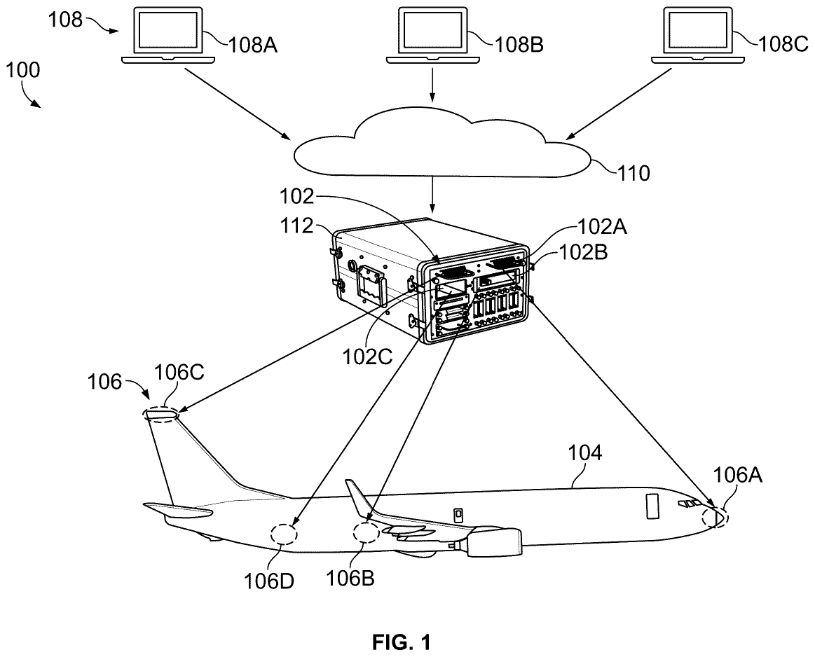

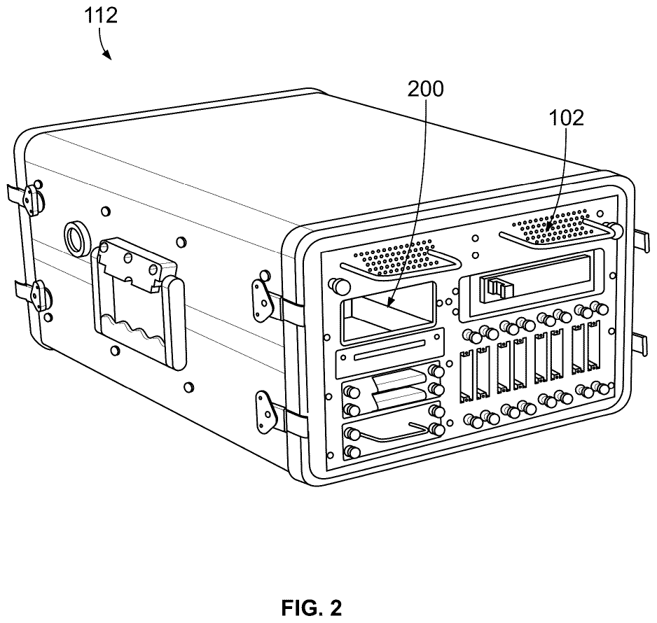

FIG. 1 illustrates one example of a mission planning and media management system 100. The mission planning and media management system 100 can operate as a central framework for coordinating and managing mission data for aircraft 104. This management system 100 can integrate with various components to facilitate the creation, validation, and deployment of mission media. The management system 100 can use a web-based architecture that allows communication between a networked media station 112 and remote computer machines 108 (e.g., machines 108A-C) via one or more computerized communication networks 110 (e.g., the Internet, one or more intranets, wide area networks, local area networks, or the like). This allows multiple remotely located users to interact with the networked media station or system 100 through a web interface. This setup can increase collaboration and operational flexibility by allowing users to access and manage mission data from any location with an internet connection. Additionally, this interface can allow users to use a variety of different machines 108, such as desktop computers, laptop computers, tablet computers, mobile phones, or the like, instead of dedicated desktop computers.

With continued reference to the system 100 shown in FIG. 1, FIG. 2 illustrates one example of the networked media station 112 shown in FIG. 1. The networked media station 112 can represent hardware circuitry including and/or connected with one or more processors (e.g., one or more microprocessors, field programmable gate arrays, integrated circuits, application specific integrated circuits, or the like) that perform operations described herein in connection with the station 112. The station 112 can include communication circuitry (e.g., modems, transceivers, antennas, etc.) that allow communication with the machines 108 via the network(s) 110. The media station 112 can include several memory modules 102, or sleds, that store mission media. These modules 102 can be removed from memory module bays 200 in the networked media station or system 100 for insertion into a centralized control system or the different control systems 106 of the aircraft 104.

The networked media station 112 may be provide an intuitive web browser-based user interface that requires no specific computer language or operating system training. The networked media station 112 can support software plugins and virtualization for WINDOWS applications, thereby allowing integration of customer-specific tools for planning, analysis, replay, and/or training. The networked media station 112 can load output from a mission planning component (MPC) or a joint mission planning system (JMPS) as PID files. The networked media station 112 provides for editing capabilities of at least some of the PID or other data. For example, the networked media station 112 can be used to change PID or other data. The networked media station 112 can be portable. For example, the outer or largest dimensions of the networked media station 112 can be no more than fifteen inches by twenty-two inches by nine inches, or another size. The networked media station 112 can be light (e.g., less than forty pounds or another weight).

The memory modules 102 can provide consistent and reliable reproduction of mission media by holding pre-planned mission packages and/or allowing remotely located users from creating and/or modifying mission packages using the machines 108 via the web interface. Each memory module 102 can store mission data for one or more of the control systems 106 of the aircraft 104. The memory modules 102 can be loaded into the aircraft 104 and a centralized mission system onboard the aircraft 104 can access the data stored on the modules 102 and share the specific mission data for each of the control systems 106 based on which data is needed by those control systems 106. For example, the memory modules 102 can individually or collectively store mission media (or packages) for a radar control system 106A, mission media or packages for a communications control system 106B, mission media or packages for a satellite communication system 106C, mission media or packages for a weapons control system 106D, and so on. The centralized mission system can access this information from the modules 102 and send different portions of the information to the different control systems 106 as needed by those control systems 106. The memory modules 102 can represent different types of hardware that can store data, such as solid-state drives (SSDs) or hard disk drives (HDDs).

In one example, the networked media station 112 is or includes an artificial neural network (ANN), such as a type of machine learning model used to perform a wide variety of complex tasks described herein. The ANN can be realized through software and/or hardware. The structure of the ANN can be a series of layers, with each layer including one or more neurons arranged in one or more neuron arrays. Each neuron may include a register, a microprocessor, and at least one input. Each neuron can produce an output or activation based on an activation function that uses the outputs of the previous layer and a set of weights as inputs. Each neuron in a neuron array may be connected to another neuron via a synaptic circuit. A synaptic circuit may include a memory for storing a synaptic weight. The ANN may be a Deep Neural Network having an input layer, an output layer, and a plurality of fully connected hidden layers. In one example, the ANN may be implemented by an application-specific integrated circuit (ASIC).

In certain examples, the system 100 can incorporate a machine learning model to enhance the operation and functionality of the networked media station 112. The machine learning model may be configured to analyze mission media, mission logs, and user interactions to identify patterns, predict potential issues, and generate recommendations for optimizing mission planning and media management processes. Training of the model can be performed using historical mission data, operational outcomes, and user feedback collected through the networked media station 112. As additional mission data and user interactions are accumulated, the model can be continuously refined and updated to improve its predictive accuracy and the relevance of its recommendations. The machine learning model can be trained to improve functionality of the system 100 (and the networked media station 112) over time. By training the machine learning model on multiple tasks, once the model has been trained, the model can be used for each of the multiple tasks with an acceptable level of performance. As a result, systems that need to be able to achieve acceptable performance on multiple tasks can do so while using less storage capacity and having reduced system complexity. For example, by training the model on a new task by adjusting values of parameters of the model to optimize an objective function that depends in part on how important the parameters are to previously learned task(s), the model can effectively learn new tasks in succession while protecting knowledge about previous tasks. This adaptive approach enables the system 100 to proactively assist users in creating more effective mission packages, identifying configuration errors before deployment, and suggesting improvements for future missions, thereby increasing the reliability, efficiency, and overall performance of the mission planning and media management system.

The aircraft 104 can represent the vehicle that utilizes the mission media managed by the system 100. The aircraft 104 can be equipped with various control systems 106 that interact with the memory modules 102 to execute the mission. The aircraft 104 can perform surveillance, target tracking, and other mission-related tasks based on the data provided by the memory modules 102. The aircraft control systems 106 include the subsystems within the aircraft 104 that utilize the mission media stored in the memory modules 102. These control systems 106 can include radio systems, weapons systems, navigation systems, and other mission components. The control systems 106 receive the relevant media packages from the memory modules 102 to implement the pre-planned mission packages.

The remote computer machines 108 can be external devices that allow users to interact with the mission planning and media management system 100. These machines 108 connect to the networked media station 112 via the web interface to allow users to create, manage, and validate mission media remotely. The remote computer machines 108 facilitate real-time collaboration among multiple users. The first remote computer machine 108A is one of the remote computer machines 108. This machine 108A allows a user to access the web interface and interact with the networked media station 112. The first remote computer machine 108A can be used to input radio settings or other mission data. The second remote computer machine 108B functions similarly to the first remote computer machine 108A. This machine 108B allows another user to access the web interface and manage mission media. The second remote computer machine 108B can be used to input weapons configurations or other mission data. The third remote computer machine 108C can allow a third user to access the web interface and interact with the networked media station 112. The third remote computer machine 108C can be used to input navigation parameters or other mission data.

The computerized communication network 110 connects the remote computer machines 108 to the networked media station 112 within the mission planning and media management system 100. This network 110 allows the transfer of data between the remote users and the media station 112 to provide real-time collaboration and efficient management of mission media. The computerized communication network 110 can provide secure and reliable communication channels for mission planning and execution.

The memory module bays 200 house the memory modules 102 within the mission planning and media management system 100. The bays 200 provide secure and organized storage for the memory modules 102 to ensure that the modules 102 are readily accessible for insertion and removal. The memory module bay 200 includes multiple slots, each designed to accommodate a specific memory module 102. The bay 200 connects to the internal components of the media station 112 to allow for the transfer of data between the memory modules 102 and the media station 112. The design of the memory module bay 200 ensures that the memory modules 102 are securely held in place during data transfer operations to reduce the risk of data corruption or loss. The memory module bay 200 also can include mechanisms for identifying and validating the data stored in the memory modules 102. These mechanisms can ensure that the correct memory modules 102 are used for specific missions and that the data stored on the modules is accurate and up-to-date.

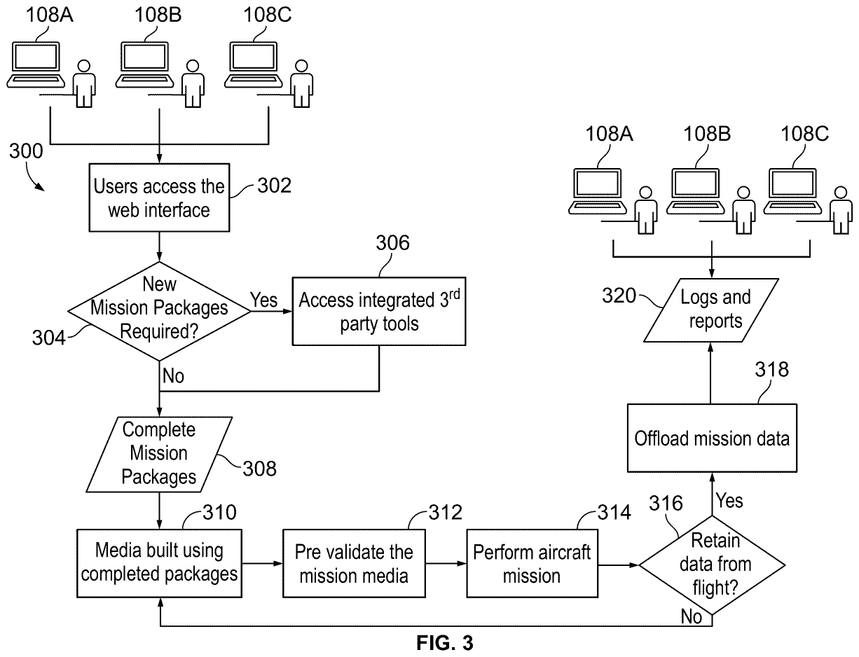

FIG. 3 illustrates a flowchart of one example of a method 300 for planning missions and managing media used to plan and implement the missions. The method 300 can represent operations performed by the management system 100 shown in FIG. 1. At 302, the remote computer machines 108A, 108B, and 108C can access the web interface of the mission planning and media management system 100. The users may log into the system 100 via the web interface and network(s) 110, establishing connections between the machines 108 and the media station 112 through the computerized communication network 110. This can help the users begin interacting with the system 100 to access the necessary tools and data for mission planning and media management.

At 304, a decision is made as to whether new mission packages are needed for an upcoming mission. For example, some mission packages may be able to be re-used by the same aircraft 104 or by different aircraft 104 for multiple missions. If new mission packages are required, then flow of the method 300 can proceed toward 306. Otherwise, if previously created mission packages can be re-used, then flow of the method 300 can proceed toward 308.

At 306, the users may employ third party tools (e.g., software applications) to create and/or modify the mission packages. These third party tools can be software applications accessible via the web interface provided by the media station 112. These third party tools may be accessible via the network(s) 110 instead of requiring the tools to be pre-installed on the machines 108. Optionally, one or more of the tools may not be a third party tool and/or may already be installed on the machine(s) 108.

At 308, new mission packages are created and/or existing mission packages are updated for an upcoming mission. In one example, these mission packages can be created using the machines 108 remotely interacting with the media station 112 via the network(s) 110 using the third party tools. Users can input data and configure settings for various mission parameters, such as radio settings, weapons settings, and navigation settings. The media station 112 can store these configurations in removable memory modules 102 so that the mission packages are ready for deployment.

At 310, media (e.g., data) is built using the completed mission packages. For example, the users can select and/or input information for the mission packages at 306 and/or 308, and this information is used to create the media to be uploaded into the control systems 106 of the aircraft 104. At 312, the mission media is pre-validated. This can involve performing validation checks to identify and report any issues that may prevent the successful implementation of the mission packages on the control systems 106 of the aircraft 104, such as checks on whether the media in the packages are incompatible with each other, whether media required for completion of the mission is missing, whether media is incorrectly formatted, or the like. This step ensures that the mission media is accurate and reliable before deployment, thereby saving time and effort that otherwise may be required to repeatedly take the modules 102 to and from the control systems 106 of the aircraft 104. The mission media can then be loaded into the control systems 106 by removing the memory modules 102 from the media station 112, taking the memory modules 102 to the appropriate control systems 106, loading the memory modules 102 into corresponding bays (e.g., similar to the bays 200) in the control systems 106, and downloading the media into the control systems 106 and/or leaving the modules 102 in the control systems 106.

At 314, the mission of the aircraft 104 is performed. During performance of the mission, the media provided by the modules 102 can be used by the control systems 106 to complete various tasks described herein. One or more of the modules 102 can record data from the mission. For example, during missions, the control systems 106 can collect a variety of mission data that can be useful for post-mission analysis and future planning. This data can include navigation data, communication logs, weapons deployment data, sensor and surveillance data from radar, sonar, infrared, and other surveillance equipment, environmental data, operational logs, logistics and support data, intelligence data, mission logs and reports for review, etc. This collected data can be stored in the modules 102.

At 316, a decision is made as to whether the collected mission data is to be retained. For example, the data collected during the mission can be used for evaluation of the mission, identifying areas for improvement, and informing future mission planning. If the data is to be retained, then flow of the method 300 can proceed toward 318. Otherwise, flow of the method 300 can return to another operation (e.g., 310) or the method 300 may terminate.

At 318, the mission data collected or generated during the mission is offloaded and at 320, one or more mission logs and reports can be generated. The mission data can be offloaded from the aircraft control systems 106 to the media station 112 after the aircraft 104 completes the mission (e.g., for review). The data recorded during the flight, including parameters such as locations, airspeed, altitudes, camera footage, acoustic recordings, user actions on crew workstations, and other relevant information, can be transferred to the media station 112. This offloading process can be performed by the removable memory modules 102 that were used to load the mission media into the aircraft control systems 106. These memory modules 102 (now storing the mission data) can be removed from the aircraft control systems 106 and inserted back into the memory module bays 200 of the media station 112. The remote users can use the machines 108 to access the offloaded data through the web interface to allow the users to review, analyze, and generate reports on the mission outcomes. These reports can then be reviewed for potential changing of mission media for upcoming missions or flights. This process can make sure that mission data is efficiently captured, securely stored, and readily accessible for post-mission analysis and validation. This can increase the overall reliability and effectiveness of mission planning and execution.

Flow of the method 300 can then terminate or can return to one or more other operations, such as 302 or 304, for another mission.

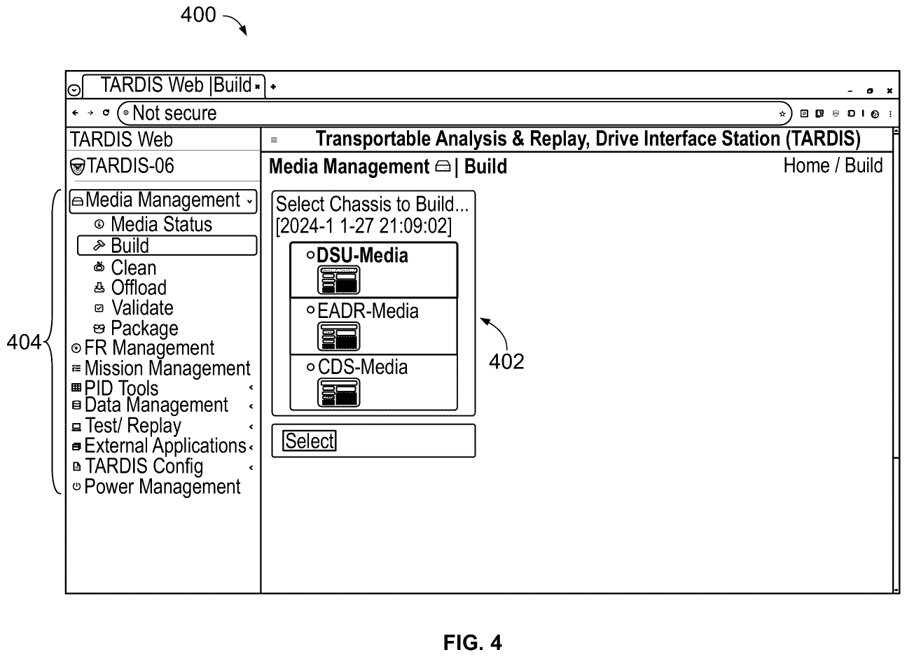

FIG. 4 illustrates one example of a media building graphical user interface (GUI) 400. The users can access this GUI 400 through the machines 108. The GUI 400 provides a user-friendly interface for managing various tasks related to mission planning and media management. The GUI 400 includes several selectable tools 404, which may be third-party tools for building mission packages, cleaning or deleting data, offloading data or media packages, validating mission packages, forming the mission packages, or similar tasks. The GUI 400 features a build icon 402 that allows users to graphically select one or more of the memory modules in the bays. Users can create, modify, or delete data in the selected module using the tools 404. The tools 404 can be listed on the left side of the GUI 400, providing easy access to functionalities such as media status, build, clean, offload, validate, package, mission management, data management, test/replay, external applications, configurations, and power management. The build icon 402 allows for the selection of specific memory modules 102, enabling users to manage the data stored within these modules 102. The GUI 400 allows the users to interact with the system 100 and the media station 112 using the available tools 404 to perform necessary operations on the mission media.

As described above, the mission planning and media management system 100 can have a plug-in architecture that enables the integration of training tools and other customer-specific applications. These tools and icons may be activated using one or more of the selectable tools 404 shown in FIG. 4. For example, at least one of the tools 414 may be selected to activate a tool for training, planning, analysis, or replay. The plug-in tools can refer to software components or modules that are integrated with the host application of the system 100 to provide additional features or functionalities beyond those originally included in the host application. The plug-ins can operate in conjunction with the host application through a defined interface or protocol, allowing the plug-ins to be installed, removed, or updated independently of the core system 100. The plug-in architecture of the system 100 enables users to incorporate customer-specific or third-party tools (such as training, planning, analysis, or replay modules) into the mission planning and media management system 100 without requiring modification of the underlying platform. This approach facilitates extensibility and customization of the system 100 to address evolving operational requirements.

For example, the training plug-ins (e.g., tools 404) may be used to simulate mission scenarios, provide interactive instruction on the use of mission planning and media management features of the system 100, or facilitate the rehearsal of operational procedures in a controlled environment. For example, a training plug-in may allow users to practice configuring mission packages, validate simulated mission media, or replay historical mission data for after-action review and analysis. Additional examples include plug-ins that deliver step-by-step tutorials for new users, modules that generate simulated mission data for training exercises, or tools that enable collaborative training sessions among geographically dispersed users. By supporting the integration of such training tools, the system 100 enhances user proficiency and readiness while maintaining flexibility to accommodate evolving training requirements.

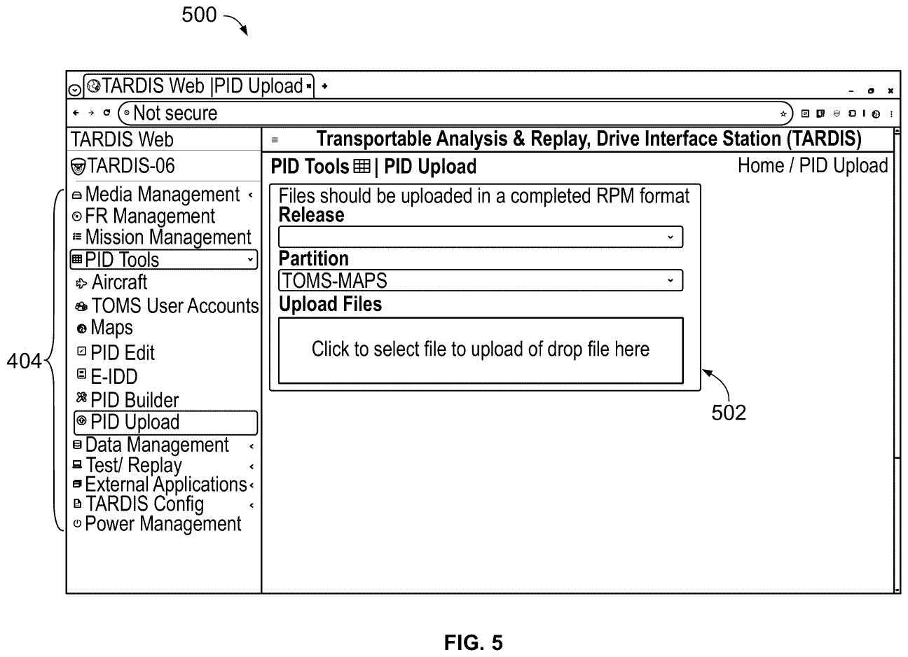

FIG. 5 illustrates one example of a media uploading GUI 500. The GUI 500 is accessible to users operating machines 108. The GUI 500 includes the tool list 404. The GUI 500 also features a package upload icon 502. The package upload icon 502 allows users to graphically upload one or more previously created mission packages. These mission packages can be stored locally on the machines 108, remotely in the modules 102, or in another location. Once uploaded, the data can be created, modified, or deleted in the selected module 102 using the tools 404. The package upload icon 502 allows users to handle mission packages efficiently. The GUI 500 can serve as a central interface for mission planning and media management and can provide seamless interaction with the networked media station.

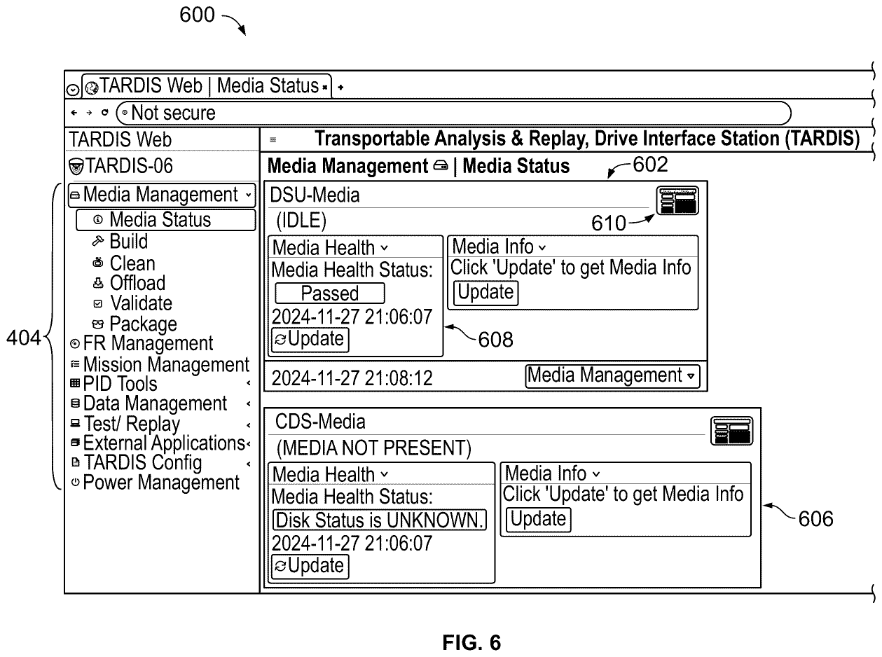

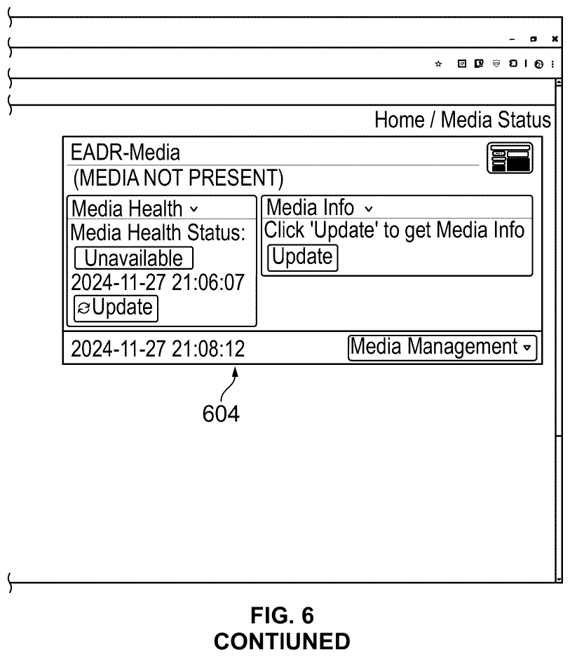

FIG. 6 illustrates one example of a media status GUI 600. The users can access this GUI 600 through the machines 108. The GUI 600 can provide a comprehensive interface for managing and monitoring the status of various memory modules 102 within the media station 112. The GUI 600 includes the tool list 404 and several media status icons, including a first memory module status icon 602, a second memory module status icon 604, a third memory module status icon 606, and so on.

Each of the module status icons can represent a different memory module 102 located in a different bay 200 of the media station 112. These icons 602, 604, 606 can provide a visual representation of the status and health of the respective memory modules 102. The module status icons 602 can include an internal health status icon 608, which indicates the health or status of the memory module 102. The health status can show various states such as “healthy” or “passed several checks,” or “unavailable,” indicating that the memory module 102 has been removed or is otherwise not operational. The memory module location map 610 can provide a visual representation of the physical location of the memory module 102 within the media station 112. The GUI 600 allows users to quickly assess the status and health of each memory module 102, which can be helpful in managing and troubleshooting the media station 112.

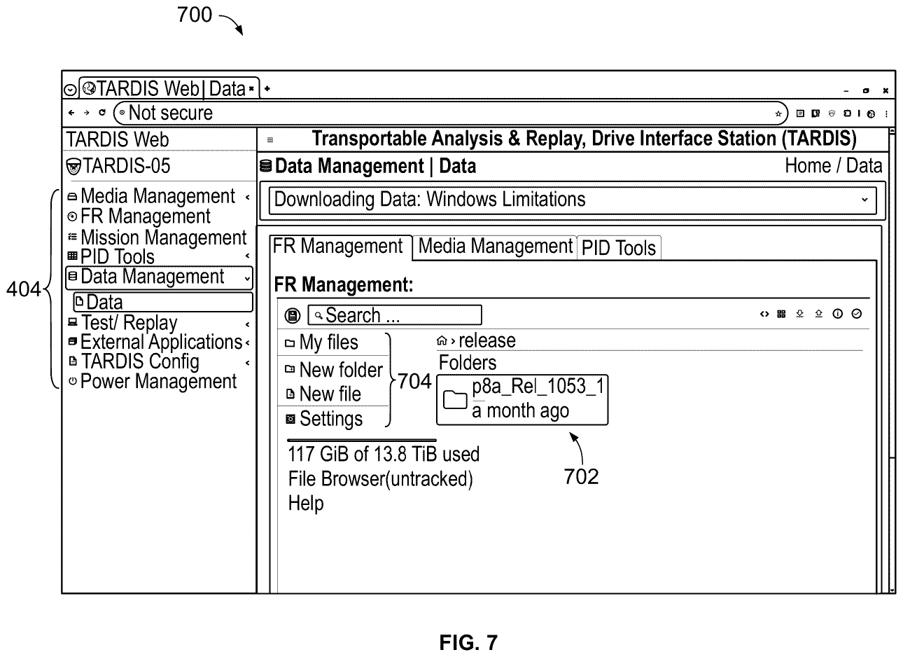

FIG. 7 illustrates one example of a data management GUI 700. The GUI 700 can be used by the users for browsing media packages or files within the media station 112. The GUI 700 can allow users to view the files in the media packages through the intuitive web-based interface. The data management GUI 700 includes a file management tool list 404, which provides users with various tools for managing files and media packages. The file management tool list 404 is located on the left side of the interface and includes options such as “Media Management,” “Data Management,” and “FR Management,” among others. These tools enable users to perform a range of tasks related to media and data management. The GUI 700 also features file management icons 702, which represent folders and files within the system. These icons allow users to navigate through different directories and access specific files or folders. In the example shown, a folder named “p8a_Rel_1053_1” is visible, indicating a specific media package or data set stored within the system. Several media tools 704 are provided within the GUI 700, allowing users to view folders, files, etc. These tools are accessible through the interface and enable users to organize and manage their media packages efficiently. The “New Folder” and “New File” options allow users to create new data or media packages for storage on the modules 102, while the “Settings” option provides access to configuration settings for the media management system. The data management GUI 700 is designed to be user-friendly, enabling users to interact with the system without requiring extensive programming knowledge. This interface allows users to view media packages, ensuring that data is accurately prepared and stored for use in various control systems of the aircraft.

In one example, users of the system 100 are not limited in the ways in which the icons 502, 602, 604, 606, 608, 610, 702, and/or 704 are presented in the GUIs 400, 500, 600, and/or 700. Users of the system 100 may have a large number of the icons 502, 602, 604, 606, 608, 610, 702, and/or 704 shown on a display. This can make it more difficult on users to find the icons 502, 602, 604, 606, 608, 610, 702, and/or 704 used most or that are most applicable to the task at hand. Typically available ways to organize icons are alphabetically, by file size, and by file type. But the user may not want this organization of the icons 502, 602, 604, 606, 608, 610, 702, and/or 704. The system 100 can move the most used of the icons 502, 602, 604, 606, 608, 610, 702, and/or 704 to positions on the GUI 400, 500, 600, 700 (e.g., closest to a “start” icon or other location of the system 100), based on a determined amount of use of the tools associated with the icons 502, 602, 604, 606, 608, 610, 702, and/or 704. In one example, the amount of use of each icon 502, 602, 604, 606, 608, 610, 702, and/or 704 is automatically determined by the networked media station 112 that tracks the number of times each icon 502, 602, 604, 606, 608, 610, 702, and/or 704 is selected or how much memory has been allocated to the individual processes associated with each icon 502, 602, 604, 606, 608, 610, 702, and/or 704 over a period of time (e.g., day, week, month, etc.). In another example, the user can choose to manually enter which icons 502, 602, 604, 606, 608, 610, 702, and/or 704 are used most often using another ordering and/or ranking systems.

In one example, the system 100 for distributed mission planning and media management for aircraft utilizes a web-based architecture that allows multiple remote users to interact with a networked media station 112 through a web interface. This networked media station 112 is equipped with multiple memory bays 200 that hold several removable memories 102. These removable memories 102 can be taken out of the networked media station 112 and inserted into different control systems 106 of the aircraft 104. The system 100 receives user inputs via the web interface to create and manage pre-planned mission packages for the aircraft 104, which are stored in one or more of the removable memories 102. The system preemptively validates the mission media represented by the pre-planned mission packages through the web interface to identify and report any issues that could prevent successful implementation on the aircraft 104. In another example, the system 100 can include a mobile application interface generated by the networked media station 112, allowing multiple remote users to access mission planning and media management tools from mobile devices. Additionally, the system 100 can incorporate cloud-based storage for mission media following the completion of an aircraft mission, providing automatic backups and data redundancy. Furthermore, the system 100 can analyze the mission media using an artificial intelligence (AI) system to identify recommendations for changing or creating pre-planned mission packages for future missions. The user inputs can also be received from third-party mission planning software tools, and the pre-planned mission packages can be reused in the power systems 106 of the aircraft 104 or another aircraft 104 for consistent and reliable reproduction of the aircraft mission media.

The inventive subject matter is directed to a specific improvement in the field of mission planning and media management for aircraft, providing a web-based distributed system that enables multiple remote users to collaboratively generate, validate, and manage mission media through a networked media station. Unlike generic computer implementations or abstract ideas, the disclosed system 100 is rooted in a particular technological environment and addresses concrete technical challenges associated with prior mission planning tools, such as limited collaboration, configuration management deficiencies, integration difficulties, validation gaps, and inefficient data accessibility. The inventive subject matter leverages a novel combination of hardware and software, including a networked media station with multiple memory bays for removable media, a secure web-based interface, and a plug-in architecture for extensibility, to achieve real-time collaboration, preemptive validation, and reliable deployment of mission media to aircraft control systems.

The system's architecture is not merely a generic computer performing conventional steps but rather provides a technological solution to problems unique to the domain of aircraft mission planning. For example, the system enables simultaneous offloading of mission data from multiple aircraft partitions, automated generation of mission log reports, and integration with third-party tools, all of which require specific technical implementations and improvements over existing systems. The preemptive validation of mission media prior to deployment, as well as the ability to reuse and manage pre-planned mission packages, enhances the reliability and reproducibility of mission execution, reducing the risk of mission failure due to data errors or incompatibilities. These features are implemented through specific technical means, such as the use of privileged services for secure media access, parallel I/O operations for efficient data handling, and defined protocols for plug-in integration.

Furthermore, the inventive subject matter is directed to a practical application that transforms the way mission media is created, validated, and managed for aircraft operations. The claimed systems and methods result in improved functionality of the underlying computer technology and provide tangible benefits in the operational context, such as increased efficiency, reduced error rates, and enhanced mission readiness.

Further, the disclosure comprises examples according to the following clauses:

Clause 1: A computer-implemented method for distributed mission planning and media management for aircraft, involving a web-based architecture that allows multiple remote users to interact with a networked media station through a web interface. The networked media station has multiple memory bays holding removable memories, which can be inserted into different control systems of the aircraft. The method includes receiving user inputs via the web interface to create and manage pre-planned mission packages stored in the removable memories, and preemptively validating the mission media to identify and report issues preventing successful implementation on the aircraft.

Clause 2: The method of Clause 1: Further includes simultaneous offloading of mission data from the different control systems of the aircraft following completion of an aircraft mission to the networked media station through the web interface.

Clause 3: The method of Clause 2: Further includes automatically generating reports from the offloaded mission data using the networked media station, and publishing the generated reports for review by multiple remote users through the web interface.

Clause 4: The method of Clause 1: Further includes generating a mobile application interface using the networked media station to allow multiple remote users to access mission planning and media management tools from mobile devices.

Clause 5: The method of Clause 1: Further includes incorporating cloud-based storage of mission media following completion of an aircraft mission using the networked media station to provide automatic backups and data redundancy.

Clause 6: The method of Clause 5: Further includes analyzing the mission media using an artificial intelligence (AI) system to identify recommendations for changing or creating pre-planned mission packages for future missions of the aircraft or another aircraft.

Clause 7: The method of Clause 1: Further includes analyzing the pre-planned mission packages using an artificial intelligence (AI) system to identify recommendations for changing or creating pre-planned mission packages.

Clause 8: The method of Clause 1: Wherein the user inputs are received via the web interface from third-party mission planning software tools.

Clause 9: The method of Clause 1: Wherein the pre-planned mission packages are configured to be reused in the power systems of the aircraft or in another aircraft for future missions, ensuring consistent and reliable reproduction of the aircraft mission media.

Clause 10: A computer-readable storage device storing instructions which, when executed by one or more processors, cause the processors to perform operations for distributed mission planning and media management for aircraft. The operations include providing a web-based architecture for multiple remote users to interact with a networked media station through a web interface, receiving user inputs to create and manage pre-planned mission packages stored in removable memories, and preemptively validating the mission media to identify and report issues preventing successful implementation on the aircraft.

Clause 11: The computer-readable storage device of Clause 10: Wherein the instructions cause the processors to perform operations that also include simultaneous offloading of mission data from the different control systems of the aircraft following completion of an aircraft mission to the networked media station through the web interface.

Clause 12: The computer-readable storage device of Clause 11: Wherein the instructions cause the processors to perform operations that also include automatically generating reports from the offloaded mission data using the networked media station, and publishing the generated reports for review by multiple remote users through the web interface.

Clause 13: The computer-readable storage device of Clause 10: Wherein the instructions cause the processors to perform operations that also include generating a mobile application interface using the networked media station to allow multiple remote users to access mission planning and media management tools from mobile devices.

Clause 14: The computer-readable storage device of Clause 10: Wherein the instructions cause the processors to perform operations that also include incorporating cloud-based storage of mission media following completion of an aircraft mission using the networked media station to provide automatic backups and data redundancy.

Clause 15: The computer-readable storage device of Clause 14: Wherein the instructions cause the processors to perform operations that also include analyzing the mission media using an artificial intelligence (AI) system to identify recommendations for changing or creating pre-planned mission packages for future missions of the aircraft or another aircraft.

Clause 16: The computer-readable storage device of Clause 10: Wherein the instructions cause the processors to perform operations that also include analyzing the pre-planned mission packages using an artificial intelligence (AI) system to identify recommendations for changing or creating pre-planned mission packages.

Clause 17: The computer-readable storage device of Clause 10: Wherein the user inputs are received via the web interface from third-party mission planning software tools.

Clause 18: The computer-readable storage device of Clause 10: Wherein the pre-planned mission packages are configured to be reused in the power systems of the aircraft or in another aircraft for future missions, ensuring consistent and reliable reproduction of the aircraft mission media.

Clause 19: A computer-implemented method for distributed mission planning and media management for aircraft, involving a web-based architecture that allows multiple remote users to interact with a networked media station through a web interface. The networked media station has multiple memory bays holding removable memories, which can be inserted into different control systems of the aircraft. The method includes receiving user inputs via the web interface to create and manage pre-planned mission packages stored in the removable memories, and configuring the pre-planned mission packages to be reused in the power systems of the aircraft or in another aircraft for future missions, ensuring consistent and reliable reproduction of the aircraft mission media.

Clause 20: The method of Clause 19: Further includes simultaneous offloading of mission data from the different control systems of the aircraft following completion of an aircraft mission to the networked media station through the web interface.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A computer-implemented method for distributed mission planning and media management for aircraft, the method comprising:
providing a web-based architecture that allows multiple remote users to interact with a networked media station through a web interface, the networked media station having plural memory bays holding plural removable memories configured to be removed from the networked media station and inserted into different control systems of the aircraft;
receiving, at the networked media station, user inputs via the web interface, to create and manage pre-planned mission packages for the aircraft, the pre-planned mission packages stored in one or more of the removable memories via the networked media station; and
preemptively validating mission media represented by the pre-planned mission packages using the networked media station through the web interface to identify and report issues preventing successful implementation of any of the pre-planned mission packages on the aircraft,
wherein the one or more of the removable memories are removable from the networked media station for loading into the different control systems of the aircraft for implementing the pre-planned mission packages using the aircraft.

2. The computer-implemented method of claim 1, further comprising:
simultaneous offloading of mission data from the different control systems of the aircraft following completion of an aircraft mission to the networked media station through the web interface.

3. The computer-implemented method of claim 2, further comprising:
automatically generating reports from the mission data that is offloaded using the networked media station; and
publishing the reports that are generated for review by the multiple remote users through the web interface using the networked media station.

4. The computer-implemented method of claim 1, further comprising:
generating a mobile application interface using the networked media station to allow the multiple remote users to access mission planning and media management tools from mobile devices.

5. The computer-implemented method of claim 1, further comprising:
incorporating cloud-based storage of mission media following completion of an aircraft mission using the networked media station to provide automatic backups and data redundancy of the mission media.

6. The computer-implemented method of claim 5, further comprising:
analyzing the mission media using an artificial intelligence (AI) system to identify one or more recommendations for changing or creating one or more of the pre-planned mission packages for a future mission of the aircraft or another aircraft.

7. The computer-implemented method of claim 1, further comprising:
analyzing the pre-planned mission packages using an artificial intelligence (AI) system to identify one or more recommendations for changing or creating one or more of the pre-planned mission packages.

8. The computer-implemented method of claim 1, wherein the user inputs are received via the web interface from third-party mission planning software tools.

9. The computer-implemented method of claim 1, wherein the pre-planned mission packages are configured to be reused in the control systems of the aircraft or in another aircraft for future missions for consistent and reliable reproduction of the mission media.

10. A computer-readable storage device storing instructions which, when executed by one or more processors, cause the one or more processors to perform operations for distributed mission planning and media management for aircraft, the operations comprising:
providing a web-based architecture that allows multiple remote users to interact with a networked media station through a web interface, the networked media station having plural memory bays holding plural removable memories configured to be removed from the networked media station and inserted into different control systems of the aircraft;
receiving, at the networked media station, user inputs via the web interface, to create and manage pre-planned mission packages for the aircraft, the pre-planned mission packages stored in one or more of the removable memories via the networked media station; and
preemptively validating mission media represented by the pre-planned mission packages using the networked media station through the web interface to identify and report issues preventing successful implementation of any of the pre-planned mission packages on the aircraft,
wherein the one or more of the removable memories are removable from the networked media station for loading into the different control systems of the aircraft for implementing the pre-planned mission packages using the aircraft.

11. The computer-readable storage device of claim 10, wherein the instructions cause the one or more processors to perform the operations that also comprise:
simultaneous offloading of mission data from the different control systems of the aircraft following completion of an aircraft mission to the networked media station through the web interface.

12. The computer-readable storage device of claim 11, wherein the instructions cause the one or more processors to perform the operations that also comprise:
automatically generating reports from the mission data that is offloaded using the networked media station; and
publishing the reports that are generated for review by the multiple remote users through the web interface using the networked media station.

13. The computer-readable storage device of claim 10, wherein the instructions cause the one or more processors to perform the operations that also comprise:
generating a mobile application interface using the networked media station to allow the multiple remote users to access mission planning and media management tools from mobile devices.

14. The computer-readable storage device of claim 10, wherein the instructions cause the one or more processors to perform the operations that also comprise:
incorporating cloud-based storage of mission media following completion of an aircraft mission using the networked media station to provide automatic backups and data redundancy of the mission media.

15. The computer-readable storage device of claim 14, wherein the instructions cause the one or more processors to perform the operations that also comprise:
analyzing the mission media using an artificial intelligence (AI) system to identify one or more recommendations for changing or creating one or more of the pre-planned mission packages for a future mission of the aircraft or another aircraft.

16. The computer-readable storage device of claim 10, wherein the instructions cause the one or more processors to perform the operations that also comprise:
analyzing the pre-planned mission packages using an artificial intelligence (AI) system to identify one or more recommendations for changing or creating one or more of the pre-planned mission packages.

17. The computer-readable storage device of claim 10, wherein the user inputs are received via the web interface from third-party mission planning software tools.

18. The computer-readable storage device of claim 10, wherein the pre-planned mission packages are configured to be reused in the control systems of the aircraft or in another aircraft for future missions for consistent and reliable reproduction of the mission media.

19. A computer-implemented method for distributed mission planning and media management for aircraft, the method comprising:
providing a web-based architecture that allows multiple remote users to interact with a networked media station through a web interface, the networked media station having plural memory bays holding plural removable memories configured to be removed from the networked media station and inserted into different control systems of the aircraft; and
receiving, at the networked media station, user inputs via the web interface, to create and manage pre-planned mission packages for the aircraft, the pre-planned mission packages stored in one or more of the removable memories via the networked media station, the pre-planned mission packages configured to be reused in the control systems of the aircraft or in another aircraft for future missions for consistent and reliable reproduction of the mission media,
wherein the one or more of the removable memories are removable from the networked media station for loading into the different control systems of the aircraft for implementing the pre-planned mission packages using the aircraft.

20. The computer-implemented method of claim 19, further comprising:
simultaneous offloading of mission data from the different control systems of the aircraft following completion of an aircraft mission to the networked media station through the web interface.
